(19) United States
(12) Patent Application Publication
(10) Pub. No.: US 2026/0307545 A1
(43) Pub. Date: Oct. 8, 2026

(54) ACTUATOR FOR A VEHICLE SEAT, IN PARTICULAR FOR A SQUAB-RAISING MECHANISM OF A VEHICLE SEAT

(71) Applicant: FAURECIA Sièges d'Automobile, NANTERRE (FR)

(72) Inventors: Emil RDZANEK, PIASECZNO (PL); Nicolas NAVATTE, CONDÉ SUR NOIREAU (FR)

(21) Appl. No.: 19/639,841

(22) Filed: Apr. 6, 2026

(30) Foreign Application Priority Data
Apr. 7, 2025 (FR) 2503647

(51) Int. Cl. B60N 2/02; B60N 2/18

(52) U.S. Cl. CPC B60N 2/02253; B60N 2/181; B60N 2/1864

(57) ABSTRACT

The present disclosure relates to an actuator for a vehicle seat comprising a motor; a reduction gear driven by the output shaft of the motor, the reduction gear comprising an eccentric cam wheel driving an orbital gear wheel, an output member forming an inner ring gear receiving the orbital gear wheel, the pinion and the inner ring gear being aligned along an axis of rotation of the output member; a friction member functionally arranged between the cam of the eccentric cam wheel and the output member. The friction member is configured to generate a resistive torque on the asymmetrical output member, depending on the direction of rotation of the output member about the axis of rotation.

### PRIORITY CLAIM

This application claims priority to French Patent Application No. FR2503647, filed Apr. 7, 2025, which is expressly incorporated by reference herein.

### BACKGROUND

The present disclosure relates to an actuator for a vehicle seat, in particular a motor vehicle seat. The present disclosure relates more particularly to an actuator for a squab-raising mechanism of a vehicle seat, especially a motor vehicle seat.

### SUMMARY

According to the present disclosure, a vehicle seat actuator comprises:
a motor with an output shaft,
a reduction gear driven by the output shaft of the motor, the reduction gear comprising an eccentric cam wheel driving an orbital gear wheel,
an output member, the output member forming a pinion and an inner ring gear adapted to receive the orbital gear wheel, the pinion and the inner ring gear being aligned along an axis of rotation of the output member,
a friction member functionally arranged between the cam of the eccentric cam wheel and the output member, the friction member being configured to generate a resistive torque on the asymmetrical output member, depending on the direction of rotation of the output member about the axis of rotation.

In illustrative embodiments, the vehicle seat actuator comprises one or more of the following features, taken alone or in combination:
the orbital gear wheel is adapted to be moved in circular translation in the inner ring gear of the output member;
the vehicle seat actuator comprises a slide for guiding the orbital gear wheel in circular translation;
the friction member is elongated, extending spirally about the axis of rotation of the output member;
the friction member is attached at a first end to the cam of the eccentric cam wheel, the friction member being in contact with a radially inner wall of the output member, in the vicinity of a second, free end;
the first end of the friction member is received clamped in a receiving recess formed in the cam of the eccentric cam wheel;
the friction member comprises a central ring gear and a plurality of circular-arc arms between a first end, secured to the central ring gear, and a second, free end;
the friction member comprises a central ring gear and a plurality of arms, each arm extending substantially in a direction inclined with respect to a radial direction, between a first end, secured to the central ring gear, and a second, free end, curved in an orthoradial direction;
the output member comprises a receiving recess receiving the friction member, the receiving recess preferably being arranged axially between the pinion and the inner ring gear of the output member, the friction member preferably being in contact with a front surface of the receiving recess normal to the axis of rotation of the output member; and
the central ring gear of the friction member is in contact with a front surface of the cam of the eccentric cam wheel, normal to the axis of rotation of the output member, and wherein the second end of each of the arms is in contact with a radially inner surface of the output member.

According to another aspect, a vehicle seat is described, comprising an actuator as described above, in all combinations thereof.

The vehicle seat may in particular comprise:
a base;
a squab frame;
at least one hinge mechanism connecting the squab frame to the base, each hinge mechanism comprising at least one connecting rod mounted to rotate freely with respect to the squab frame at a first end and to the base at a second end;
at least one actuator as described above, in any combination thereof, to control the rotation of the at least one connecting rod with respect to the base or to the squab frame.

According to another aspect, a vehicle seat is proposed comprising:
a squab frame;
a device for raising the seat front edge;
at least one connecting rod connecting the squab frame to the seat front edge raising device;
at least one actuator as described above, in any combination thereof, to control rotation of the at least one connecting rod with respect to the squab frame or seat front edge raising device.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a schematic view of a vehicle seat with adjustable squab height:

FIG. 2 shows a detail of the squab of the vehicle seat of FIG. 1:

FIG. 3 is a perspective view of an actuator that can be used in the vehicle seat shown in FIG. 1:

FIG. 4 is an exploded perspective view of the actuator of FIG. 3;

FIG. 5 is a cross sectional view of the actuator in FIG. 3, along sectional plane V-V in FIG. 3;

FIG. 6 is a detail of a longitudinal cross sectional view of the actuator shown in FIG. 3;

FIG. 7 is a perspective view of the actuator shown in FIG. 3, from a cross-section along plane VII-VII of FIG. 6;

FIG. 8 shows an example of a friction member that can be used in a variant of the actuator shown in FIG. 3;

FIG. 9 is a perspective view of a longitudinal cross-section of a detail of the actuator variant of FIG. 3 using the friction member of FIG. 8;

FIG. 10 shows a longitudinal cross-section of the actuator variant of FIG. 3 using the friction member of FIG. 8;

FIG. 11 shows a cross-section of the actuator variant shown in FIG. 3, using the friction member shown in FIG. 8;

FIG. 12 is a view similar to FIG. 11;

FIG. 13 is a perspective view of another example of a friction member that can be used in a variant of the actuator shown in FIG. 3; and

FIG. 14 shows a cross-section of the actuator variant shown in FIG. 3, using the friction member shown in FIG. 13.

### DETAILED DESCRIPTION

In the various figures, the same references designate identical or similar features. For simplicity's sake, only the elements that are useful for understanding the described embodiment are shown in the figures and are described in detail below.

In the following description, when referring to terms qualifying absolute position, such as the terms “front”, “rear”, “top”, “bottom”, “left”, “right”, etc., or relative ones, such as the terms “above”, “below”, “upper”, “lower”, etc., or to qualifiers of orientation, such as “horizontal”, “vertical”, etc., reference is made, unless otherwise specified, to the orientation of the figures or a vehicle seat in its normal position of use.

In particular, the longitudinal direction X means the longitudinal direction of the seat. The longitudinal direction of the seat is considered to be the same as the longitudinal direction of the motor vehicle wherein the seat is mounted. This longitudinal direction X corresponds to the normal direction of travel of the vehicle. The longitudinal direction X is horizontal. The transverse direction Y of the seat thus corresponds to the transverse or lateral direction of the motor vehicle. This transverse direction corresponds to a direction perpendicular to the normal direction of travel of the vehicle. The transverse direction Y is horizontal. Finally, the vertical direction Z is a vertical direction of the seat, perpendicular to the longitudinal and transverse directions.

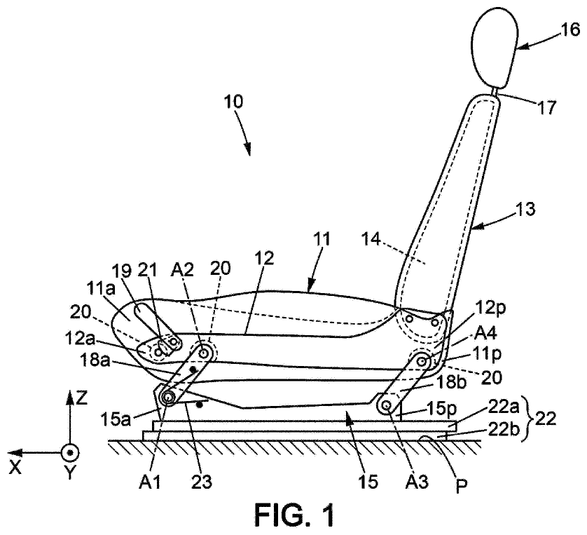

FIG. 1 schematically shows a vehicle seat 10 comprising a squab 11 with a squab frame 12, a backrest 13 with a backrest frame 14, mounted on the squab frame 12. The squab frame 12 is mounted on a base 15 via one or more hinge mechanisms. The backrest frame 13 can be secured to a headrest 16 connected to the backrest frame 13 by one or more headrest 16 attachment sockets or pins 17. In particular, the hinge mechanism(s) can be a raising mechanism and/or one or two tilting mechanisms, which can be obtained in particular but not exclusively via connecting rods 18a, 18b. For example, for each of the connecting rods 18a, 18b, the lower end is connected to the base 15 and the upper end is connected to the squab frame 12 of the vehicle seat 10. More specifically, in the example shown, a first connecting rod 18a connects the front part 15a of the base 15—mounted so as to pivot about a first transverse axis A1—to a front part 12a of the squab frame 12—mounted so as to pivot about a second transverse axis A2—and a second, rear connecting rod 18b connects the rear part 15p of the base 15—mounted so as to pivot about a third transverse axis A3—to the rear part 12p of the squab frame 12—mounted so as to pivot about a fourth transverse axis A4. In the example shown, the pivot mounts of the first and second connecting rods 18a, 18b all have axes A1-A4 parallel to the transverse direction Y.

The squab frame 12 has a right side and left side of similar architecture. In FIG. 1, only one side is shown. On the side not shown, the seat 10 has other connecting rods between the squab frame 12 and the base 15, equivalent or even identical to the connecting rods 18a, 18b shown.

If needed, the squab 11 of the seat 10 can also be fitted with a squab front edge that can be moved in height and/or longitudinal extension. In the case of the tilting movement of the squab front edge, an auxiliary connecting rod 19 connects the squab frame 12 to the squab front edge, the auxiliary connecting rod 19 being movable by an actuator 20 via a toothed sector 21. In addition, the base 15 can be slidably mounted with respect to the vehicle floor P by means of longitudinal runners 22 comprising a fixed rail 22b attached to the vehicle floor P and a movable rail 22a secured to the aforementioned base 15. The backrest 13 can be pivoted with respect to the squab 11, and in particular the backrest frame 14 with respect to the squab frame 12. The connecting rods 18a, 18b can be moved independently by respective control means or can be controlled simultaneously by synchronized control means or through a mechanical link—not shown—which can connect them. When the first connecting rod 18a is rotated trigonometrically by an actuator 20, then the front part of the squab 11a connected to the squab rises upwards, while conversely when the first connecting rod 20a is rotated clockwise then the front part 11a of the squab 11 lowers toward the floor. Similarly, when the second connecting rod 18b is rotated trigonometrically—by another actuator 20—then the rear part 11p of the squab 11 rises upwards, while when the second connecting rod 18b is rotated clockwise the rear part 11p of the squab 11 lowers toward the floor P. When both connecting rods 18a, 18b are operated simultaneously, the squab 11 moves substantially parallel to the floor P, a movement referred to as “raising”. When the first connecting rod 18a is operated without the second connecting rod 18b moving, or vice versa, a tilting movement of the squab 11 is obtained. According to an arrangement shown schematically in FIG. 1, the front hinge mechanism comprising the connecting rod 18a can be equipped with a return member 23 tending to pivot the connecting rod 18a in the trigonometric direction and exerting an upward torque on the front part 11a of the squab 11, so that the effects of gravity generated by the weight of the seat 10 and/or of the occupant installed on the seat 10 can be at least partly compensated by the effect of this return member 23. A similar return member can be provided on the second connecting rod 18b. This return member can take any other form, such as a torsion bar, which can advantageously be one of the crossbars installed at axes A1-A4.

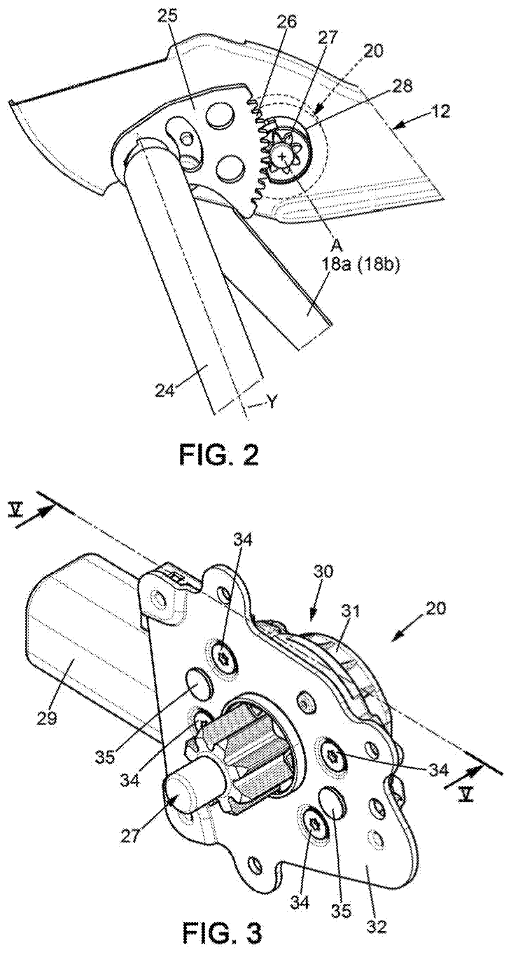

As shown in FIG. 2, the front connecting rod 18a—respectively the rear connecting rod 18b—is firmly connected to a crossbar extending along the transverse axis Y and connecting the connecting rod 18a, 18b shown to an equivalent connecting rod arranged on the other side of the squab 11, not shown. In addition, the connecting rod 18a is firmly connected to a control flange 25, which is in the form of a metal plate extending along a plane X, Z. This control flange 25 is connected directly to the crossbar 24 and/or connecting rod 18a and has, on one end of substantially circular shape, a toothed sector 26 designed to cooperate with the actuator 20, which comprises an output pinion 27 engaging directly with the toothed sector 26. Preferentially, such an actuator 20 is arranged on only one side of the squab frame 12 of the seat 10. The other side may be without actuator 20. The output pinion 27 is arranged to rotate about an axis A substantially parallel to the transverse axis Y. A second actuator, similar to the first actuator 20, can be provided to drive the rear connecting rod 18b in a similar way.

Hereinafter, a first example actuator 20 is described in more detail, in view of FIG. 3 to FIG. 7.

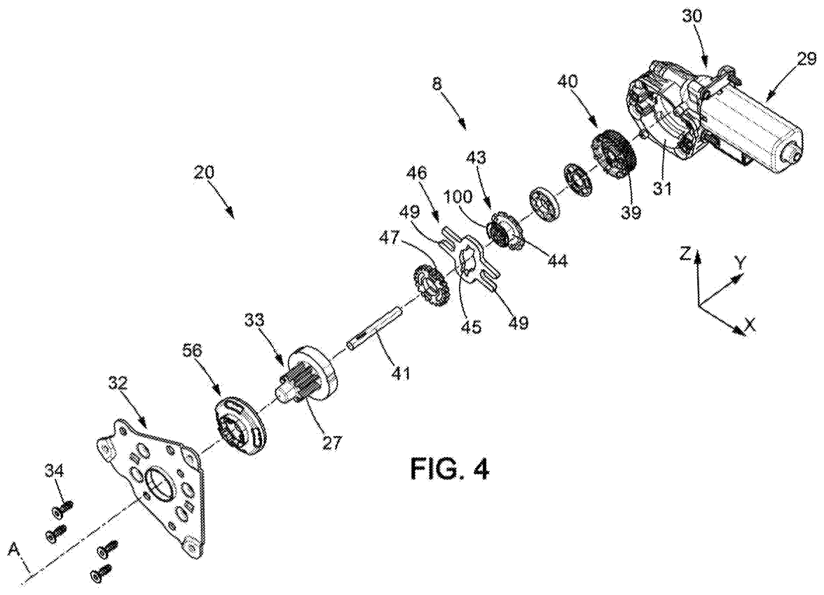

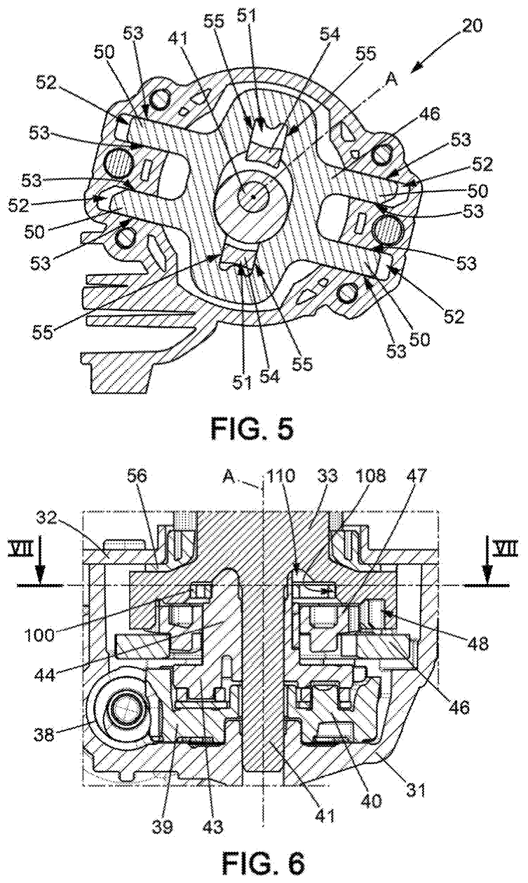

The actuator 20 comprises, as shown in FIG. 3, a motor 29, a housing 30 forming a fixed support with respect to the squab 11 of the vehicle seat 10, with a casing 31 and a flange or cover 32, and an output member 33 forming the output pinion 27. The casing 31 and cover 32 are attached together, for example by means of screws 34. Reinforcing elements 35 may also be provided between the casing 31 and the cover 32. The actuator 20 also includes a reduction gear 36, not visible in FIG. 3, which will be described below in relation to FIG. 4 and FIG. 5, in particular.

The casing 31 is shaped like a bell or bowl. In the example shown, the casing 31 is formed from plastic material. Such plastic material may be ABS, polypropylene, polyethylene, polyamide, etc. However, the casing 31 could also be formed from an aluminum alloy, magnesium alloy or any lightweight metal alloy.

The motor 29 extends along an axis perpendicular to the axis A of rotation of the output member 33 and comprises a rotor which carries, at its end, a helical gear screw 38 centered on the axis of motor 29. The helical gear screw 38 extends inside the casing 31. The helical gear screw 38 is engaged on a first outer ring gear 39 of an input member 40 of the reduction gear 36. The input member 40 is freely rotatable about the axis A by means of a shaft 41 attached to the casing 31, preferably freely rotatable about the axis of rotation A. The shaft 41 may be integral with the output member 33, or the output member 33 may be attached to the shaft 41.

The input member 40 comprises a second, inner ring gear 42, adapted to drive an eccentric cam wheel 43 in rotation about the axis of rotation A, which eccentric cam wheel features a cam 44 that is eccentric with respect to the axis of rotation A. The cam 44 is generally cylindrical in shape, with its axis parallel to the axis of rotation A. The cam 44 thus takes the form of a substantially cylindrical pin whose axis is parallel to the axis of rotation A of the eccentric cam wheel 43, offset with respect to the axis of rotation A of the eccentric cam wheel 43.

The cam 44 extends through a first opening 45 of a slide 46 guiding an orbital gear wheel 47 driven by the cam 44 of the eccentric cam wheel 43. The gear wheel 47 is received in an inner ring gear 48 of the output member 33. The orbital gear wheel 47 has a smaller diameter and number of teeth to the inner ring gear 48 of the output member 33, in order to engage with the latter and create a reduction ratio in the manner described below.

The orbital gear wheel 47 is locked in rotation on itself, about an axis parallel to the axis of rotation A of the output member 33, by means of the slide 46.

To this end, as shown in FIG. 5, the slide 46 comprises at least one first longitudinal guide element 50, as well as at least one second longitudinal guide element 51, along two perpendicular longitudinal directions in a plane perpendicular to the axis of rotation A of the output member 33.

The first longitudinal guide element 50 is adapted to cooperate with a first counter-element 52 of the casing 31 of the housing 30. The first longitudinal guide element 50 has first guide surfaces 53 adapted to slide in or against the first counter-element 52.

The first guide surfaces 53 are adapted to guide the slide 46 so that it can only move along a line with respect to the casing 31 of the housing 30.

For example, the first guide surfaces 53 can lock the slide 46 in translation with respect to the housing 30 in a vertical direction Z, perpendicular to the longitudinal X and transverse Y directions.

The slide 46 can also be locked against rotation about the axis of rotation A relative to the housing 30. Conversely, the slide 46 may be free to slide with respect to the housing 31 along the longitudinal direction X.

The cooperation of the first longitudinal guide element 50 with the first counter-element 52 therefore locks the slide 46 in translation in the vertical direction Z and in rotation about the axis of rotation A with respect to the housing 31, while leaving it free to slide in the longitudinal direction X.

The second longitudinal guide element 51 is adapted to cooperate with a second counter-element 54 of the gear wheel 47. To this end, the second longitudinal guide element 51 has second guide surfaces 55 adapted to slide against the second counter-element 54. In this way, the orbital gear wheel 47 can only move along a line with respect to the slide 46.

The second guide surfaces 55 can, for example, lock the gear wheel 47 in translation with respect to the slide 46 in the longitudinal direction X. The orbital gear wheel 47 can also be locked against rotation about the axis of rotation A with respect to the slide 46 in the vertical direction Z.

The cooperation of the second longitudinal guide element 51 with the second counter-element 54 thus locks the orbital gear wheel 47 in translation in the longitudinal direction X and in rotation about the axis of rotation A with respect to the slide 46, while leaving it free to slide in the vertical direction Z.

In this way, the gear wheel 47 can only move in circular translation with respect to the housing 30 in a plane normal to the axis of rotation A, and in particular is locked against rotation about the axis of rotation A with respect to the housing 30 due to the cooperation of the first and second longitudinal guide elements 50, 51 of the slide 46 with the first and second counter-elements 52, 54 of the casing 31 of the housing 30 and the orbital gear wheel 47.

A full circle of the orbital gear wheel 47 in the inner ring gear 48 of the output member 33 angularly shifts the output member 33 with respect to the housing 31 by the difference in the number of teeth between the orbital gear wheel 47 and the inner ring gear 48, thus generating the reduction ratio of the reduction gearbox 36.

In one embodiment, the first longitudinal guide element 50 can be formed by several extensions of rectangular cross-section, for example two or four extensions, protruding along the longitudinal direction X from a body of the slide 46. The extensions can extend two by two on either side of the body of the slide 46. In this way, the extensions can form a “U” shape with the body, on either side of the body. The two extensions can be symmetrical with respect to a longitudinal mid-plane. The flanks of the extensions can then form the first guide surfaces 53. The first counter-element 52 may then comprise longitudinal grooves in the housing 30, for example in the casing 31, to accommodate the extensions. The second longitudinal guide element 51 can be constituted by a straight opening in the slide 46, the flanks of which form the second guide surfaces 55. The second counter-element 54 may then comprise axially protruding, square-section fingers of the orbital gear wheel 47 adapted to fit into the straight opening. Alternatively, other shapes can be envisaged for the first and second longitudinal guide elements 50, 51 and the first and second counter-elements 52, 54.

As shown in FIG. 4, a bearing 56 can be arranged between the output member 33 and the cover 32 to guide the rotation of the output member 33.

Additionally, the actuator 20 here comprises a friction member 100, according to a first example, functionally arranged between the cam 44 of the eccentric cam wheel 43 and the output member 33.

As can be seen in FIG. 4 in particular, the friction member 100 here takes the form of a cylindrical strand, extending by winding about the axis of rotation A of the output member 33. The friction member 100 thus extends in a spiral. The friction member 100, for example, is polygonal in cross-section, notably rectangular or square, circular or elliptical.

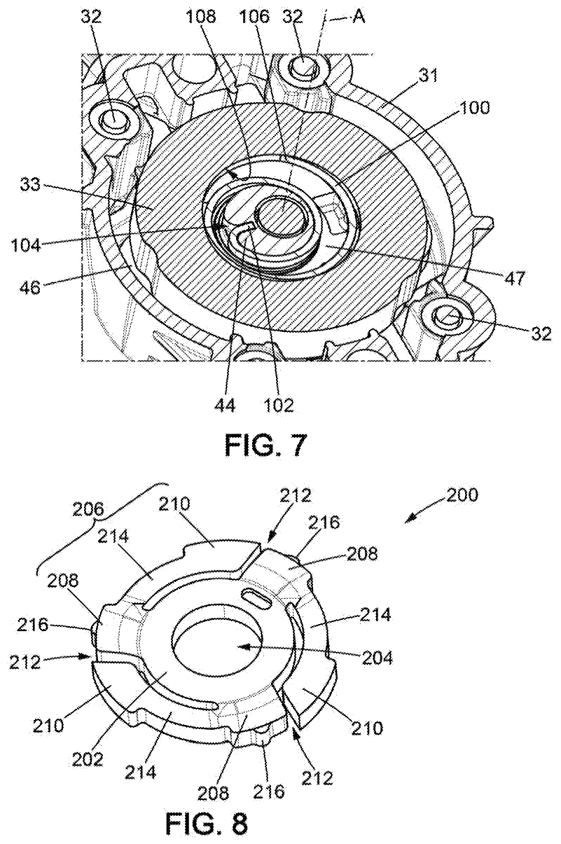

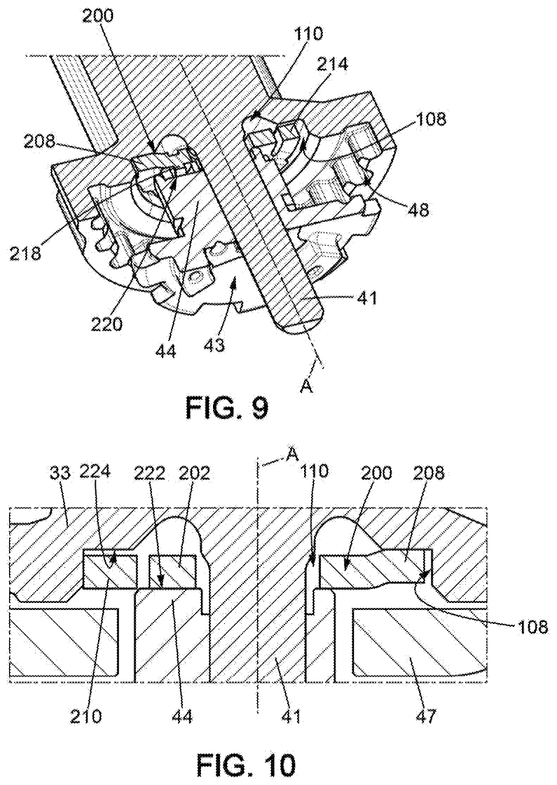

As can be seen in FIG. 7, a first end 102 of the friction member 100 is attached to the cam 44 of the eccentric cam wheel 43. Here, for this purpose, the first end 102 is received clamped in a receiving recess 104 made on the cam 44, opening onto the lateral surface of the cam 44.

In the vicinity of its second end 106, opposite the first end 102, the first friction member 100 rubs against a radially inner surface 108 of a receiving recess 110 formed in the output member 33. The receiving recess 110, accommodating the friction member 100, is arranged axially between the radially inner ring gear 48 of the output member 33 and the pinion 27.

The friction member 100 is shaped so that when the actuator 20 drives the reduction gear 36—and therefore the output member 33—in a first direction, notably in a direction tending to go against the force due to the weight of a seat occupant, then the friction of the friction member 100 on the radially inner surface 108 of the output member 33 is reduced. In this case, the friction member 100 tends to wrap around itself to reduce its outside diameter. In this way, the efficiency of actuator 20 is maintained at a high level.

On the contrary, if the reduction gear 36 is driven in a second direction—and the output member 33 by the same—opposite the first direction, then the friction of the friction member 100 on the radially inner surface 108 of the output member 33 is substantially increased. Here, in this direction of rotation of the reduction gear 36, the friction of the friction member 100 on the radially inner surface 108 of the output member 33 tends to increase the diameter of the friction member 100 and, by the same token, the friction of the output member 33 on the radially inner surface 108 of the output member 33. This reduces the risk of desynchronization in the actuator 20, by braking the gear set 36 when it is driven from the output member 33 to the motor 29. This also reduces the risk of cracking noises in the gear set 36 as it moves from a motion driven by the motor 29 to a motion driven by the output member 33.

FIG. 8 shows a second example of a friction member 200. As shown, the friction member 200 first comprises a central ring gear 202 defining a central opening 204 adapted to receive the shaft 41. The friction member 200 also comprises a plurality of arms 206, in this case three arms 206. In the example shown, the arms 206 are identical. Here, each arm 206 extends substantially orthoradially with respect to the axis of rotation A of the output member 33 between a first end 208, secured to the central ring gear 204, and a second end 210, which is free. Preferably, a clearance 212 is provided between the arms 206, that is, between the second end 210 of a first arm 206 and the first end 208 of an adjacent second arm 206. Here, each arm 206 is of reduced cross-section over a median portion 214 connecting the first end 208 and the second end 210. In contrast, the first and second ends 208, 210 have a larger cross-section. Thus, only the first and second ends 208, 210 of the arms 210 are likely to be in contact with the radially inner wall 108 of the output member 33. Additionally, here, an axial bead 216 is formed on the radially outer surface of the first end 208 of each arm 206, for contact with the radially inner surface 108 of the output member 33.

Here, moreover, the central ring gear 202 has a pin 218 adapted to be received in a complementary receiving recess 220 in the front surface 222 of the cam 44 to help hold the friction member 200 in place with respect to the cam 44. The front surface 222 extends in a plane perpendicular to the axis of rotation A of the output member 33.

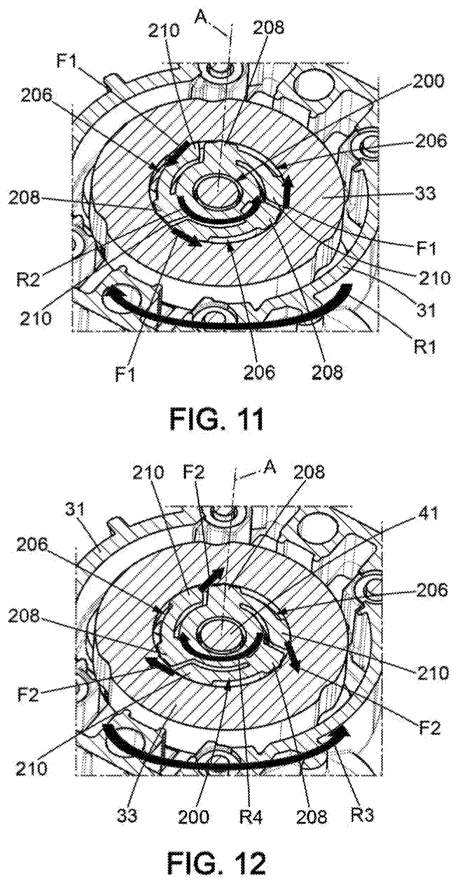

As shown in FIG. 10, the second friction member 200, here the central ring gear 202 of the second friction member 200, is in contact with the cam 44, here with the front surface 222 of the cam 44 normal to the axis of rotation A of the output member 33. The second friction member 200 is in contact with the radial surface 108 of the output member 33:
on the one hand, by the axial bead 216 which can provide substantially constant friction, whatever the relative direction of rotation of the friction member 200; and
on the other hand, by the end 210 of the arms 206, whose friction force on the output member 33 may depend on the direction of rotation R1, R2 of the output member 33, as shown in FIG. 11 and FIG. 12 by the arrows F1, F2.

Additionally, the second friction member 200 may also be in contact with a front surface 224 of the receiving recess 110, normal to the axis of rotation A of the output member 33, here via the first and/or second ends 208, 210 of the arms 206. This contact can also be substantially constant, regardless of the direction of rotation of the output member 33.

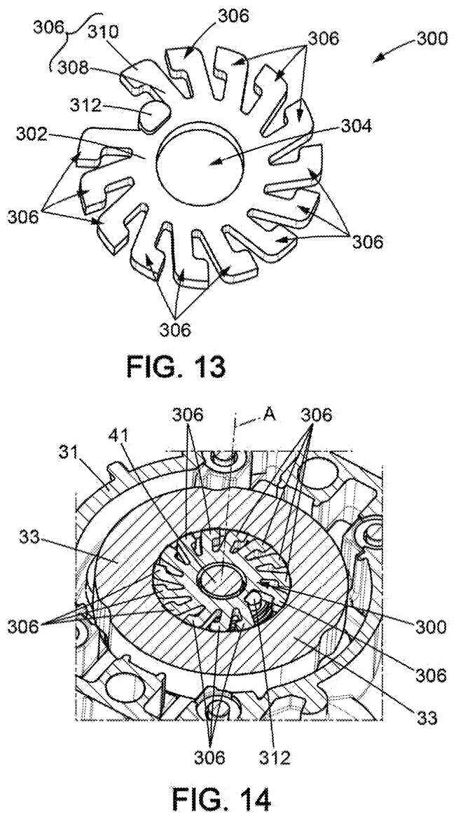

FIG. 13 and FIG. 14 show a third example of a friction member 300 that can be implemented in a drive device 20 as described above.

As shown, the friction member 300 according to this third example first comprises a central ring gear 302 defining a central opening 304 adapted to receive the shaft 41. The friction member 300 also comprises a plurality of arms 306, in this case fourteen arms 306. In the example shown, the arms 306 are identical. Here, each arm 306 extends substantially radially from the axis of rotation A of the output member 33 between a first end, secured to the central ring 304. The opposite free end 310 of each arm 306 is curved in an orthoradial direction. As shown, a clearance is preferably provided between the arms 306. Here, the clearance is substantially equal between all the arms 306 except for one pair of arms separated by a pin 312 on the central ring gear 302, which can be adapted to be received in a receiving recess complementary to the front surface of the cam 44, to help hold the friction member 300 in place with respect to the cam 44.

Here, each arm 306 is substantially constant in cross-section.

In this example, the third friction member 300 is in contact with the eccentric cam wheel 43 via the front surface of the cam 44, on the one hand, and with the radially inner surface of the output member 33, on the other hand.

Due to the shape of the friction member 300, in particular the arms 306, the friction exerted by the friction member on the output member 33 depends on the direction of rotation of the output member 33.

The present disclosure is not limited to the examples described hereinbefore by way of non-limiting illustration. On the contrary, the present disclosure is susceptible to numerous variants accessible to the person skilled in the art.

In the automotive field, in particular, a vehicle seat may have a squab frame arranged on a base, the squab being equipped with a squab-raising movement.

In this type of comparative configuration, a actuator is provided with an output member driven selectively in rotation to make the squab frame rise and/or fall. The output member comprises a toothing engaged with a toothed sector facing one another. The toothed sector is connected to the kinematics of raising and lowering the squab.

The comparative actuator comprises a reduction gear with a high reduction ratio in order to change from a rapid rotation of an electric motor to a slow or very slow rotation of the output member. The reduction gear in question has a functional clearance necessary for its operation in all circumstances. This clearance is present in particular when the electric motor is not controlled and the output pinion is not supposed to move.

Furthermore, the squab raising movement is usually provided with an upward resilient return system in order to compensate for all or some of the weight of the occupant seated on the seat, and secondarily to a part of the weight of the seat itself.

The clearance of the reduction gear can be perceptible in particular in the situations when the load polarity changes, for example when an occupant sits down on the squab or when an occupant leaves the squab.

To conceal the clearance of the reduction gear, a comparative device proposes an actuator comprising a friction ring mounted around the output member and secured in rotation to the output member. The friction ring comprising a skirt and the actuator housing comprises an inner bearing to receive the skirt. The skirt is in contact with at least the inner bearing in order to form a friction brake between the output member and the inner bearing.

By virtue of these arrangements, the contact between the skirt and the inner bearing generates a friction which is exerted as a brake when a rotation torque is applied to the output pinion.

However, this friction ring tends to reduce actuator efficiency when the actuator is motorized.

### Disclosure

The present disclosure improves the situation.

To this end, a vehicle seat actuator is proposed comprising:
a motor with an output shaft,
a reduction gear driven by the output shaft of the motor, the reduction gear comprising an eccentric cam wheel driving an orbital gear wheel,
an output member, the output member forming a pinion and an inner ring gear adapted to receive the orbital gear wheel, the pinion and the inner ring gear being aligned along an axis of rotation of the output member,
a friction member functionally arranged between the cam of the eccentric cam wheel and the output member, the friction member being configured to generate a resistive torque on the asymmetrical output member, depending on the direction of rotation of the output member about the axis of rotation.

According to preferred embodiments, the vehicle seat actuator comprises one or more of the following features, taken alone or in combination:
the orbital gear wheel is adapted to be moved in circular translation in the inner ring gear of the output member;
the vehicle seat actuator comprises a slide for guiding the orbital gear wheel in circular translation;
the friction member is elongated, extending spirally about the axis of rotation of the output member;
the friction member is attached at a first end to the cam of the eccentric cam wheel, the friction member being in contact with a radially inner wall of the output member, in the vicinity of a second, free end;
the first end of the friction member is received clamped in a receiving recess formed in the cam of the eccentric cam wheel;
the friction member comprises a central ring gear and a plurality of circular-arc arms between a first end, secured to the central ring gear, and a second, free end;
the friction member comprises a central ring gear and a plurality of arms, each arm extending substantially in a direction inclined with respect to a radial direction, between a first end, secured to the central ring gear, and a second, free end, curved in an orthoradial direction;—the output member comprises a receiving recess receiving the friction member, the receiving recess preferably being arranged axially between the pinion and the inner ring gear of the output member, the friction member preferably being in contact with a front surface of the receiving recess normal to the axis of rotation of the output member; and
the central ring gear of the friction member is in contact with a front surface of the cam of the eccentric cam wheel, normal to the axis of rotation of the output member, and wherein the second end of each of the arms is in contact with a radially inner surface of the output member.

According to another aspect, a vehicle seat is described, comprising an actuator as described above, in all combinations thereof.

The vehicle seat may in particular comprise:
a base;
a squab frame;
at least one hinge mechanism connecting the squab frame to the base, each hinge mechanism comprising at least one connecting rod mounted to rotate freely with respect to the squab frame at a first end and to the base at a second end;
at least one actuator as described above, in any combination thereof, to control the rotation of the at least one connecting rod with respect to the base or to the squab frame.

According to another aspect, a vehicle seat is proposed comprising:
a squab frame;
a device for raising the seat front edge;
at least one connecting rod connecting the squab frame to the seat front edge raising device;
at least one actuator as described above, in any combination thereof, to control rotation of the at least one connecting rod with respect to the squab frame or seat front edge raising device.

1. An actuator for a motor vehicle seat, comprising:
a motor with an output shaft,
a reduction gear driven by the output shaft of the motor, the reduction gear comprising an eccentric cam wheel driving an orbital gear wheel,
an output member, the output member forming a pinion and an inner ring gear adapted to receive the orbital gear wheel, the pinion and the inner ring gear being aligned along an axis of rotation of the output member,
a friction member functionally arranged between the cam of the eccentric cam wheel and the output member, the friction member being configured to generate an asymmetrical resistive torque on the output member, depending on the direction of rotation of the output member about the axis of rotation.

2. The actuator for a vehicle seat according to claim 1, wherein the orbital gear wheel is adapted to be moved in circular translation in the inner ring gear of the output member.

3. The actuator for a vehicle seat according to claim 1, wherein the friction member is elongated, extending spirally about the axis of rotation of the output member.

4. The actuator for a vehicle seat according to claim 3, wherein the friction member is attached at a first end to the cam of the eccentric cam wheel, the friction member being in contact with a radially inner wall of the output member, in the vicinity of a second, free end.

5. The actuator for a vehicle seat according to claim 4, wherein the first end of the friction member is received clamped in a receiving recess formed in the cam of the eccentric cam wheel.

6. The actuator for a vehicle seat according to claim 1, wherein the friction member comprises a central ring gear and a plurality of circular-arc arms between a first end, secured to the central ring gear, and a second, free end.

7. The actuator for a vehicle seat according to claim 1, wherein the friction member comprises a central ring gear and a plurality of arms, each arm extending substantially in a direction inclined with respect to a radial direction, between a first end, secured to the central ring gear, and a second, free end, curved in an orthoradial direction.

8. The actuator for a vehicle seat according to claim 6, wherein the output member comprises a receiving recess receiving the friction member.

9. The actuator for a vehicle seat according to claim 8, wherein the receiving recess is arranged axially between the pinion and the inner ring gear of the output member.

10. The actuator for a vehicle seat according to claim 9, wherein the friction member is in contact with a front surface of the receiving recess normal to the axis of rotation of the output member.

11. The actuator for a vehicle seat according to claim 6, wherein the central ring gear of the friction member is in contact with a front surface of the cam of the eccentric cam wheel, normal to the axis of rotation of the output member, and wherein the second end of each of the arms is in contact with a radially inner surface of the output member.

12. A vehicle seat, comprising the actuator according to claim 1.
